(19) United States
(12) Patent Application Publication
(10) Pub. No.: US 2013/0240418 A1
(43) Pub. Date: Sep. 19, 2013

(54) Filter Interface Security System

(71) Applicant: Amit Dhingra, McFarland, WI (US)

(72) Inventor: Amit Dhingra, McFarland, WI (US)

(73) Assignee: Cummins Filtration IP, Inc., Columbus, IN (US)

(21) Appl. No.: 13/759,364

(22) Filed: Feb. 5, 2013

Related U.S. Application Data
(60) Provisional application No. 61/612,556, filed on Mar. 19, 2012.

(51) Int. Cl. B01D 29/90

(52) U.S. Cl. CPC B01D 29/90
USPC 210/85; 210/232

(57) ABSTRACT

A filter includes a replaceable filter element cartridge in a housing. A valve is actuatable between a first condition passing dirty fluid from the housing inlet to the filter cartridge for filtration, and a second condition blocking passage of the dirty fluid from the inlet to the filter cartridge. The filter cartridge and the valve engage in keyed relation, with the keying feature utilizing an identifier, e.g. a brand, a logo, etc., verifying authenticity of the filter cartridge.

### CROSS-REFERENCE TO RELATED APPLICATIONS

This application claims the benefit of and priority from provisional U.S. Patent Application No. 61/612,556, filed Mar. 19, 2012, hereby incorporated herein by reference.

### BACKGROUND AND SUMMARY

The invention relates to filters, and more particularly to filter security systems.

It is desired to discourage intentional or inadvertent use of inappropriate filter elements, including replacement filter elements, to avoid undesirable characteristics, including unacceptable filtration removal properties, pressure drop, filter life, etc. By ensuring the installation of a correct and genuine filter, the component to be protected, e.g. an internal combustion engine or other component, is protected over the life of the component, and the required filtration performance is maintained.

The present disclosure arose during continuing development efforts in the above technology.

### BRIEF DESCRIPTION OF THE DRAWINGS

FIG. 1 is a sectional view showing a filter in accordance with the present disclosure.

FIG. 2 is a perspective view, partially cutaway, of the filter of FIG. 1.

FIG. 3 is like FIG. 2 and shows another operational condition.

FIG. 4 is a perspective view of a component of FIG. 3.

FIG. 5 is an exploded perspective view of a portion of the components of FIG. 1.

FIG. 6 is like FIG. 5 and shows another embodiment.

FIG. 7 is like FIG. 1 and shows another embodiment.

FIG. 8 is like FIG. 7 and shows another operational condition.

FIG. 9 is a perspective view of a component of FIG. 7.

FIG. 10 is an enlarged view of a portion of FIG. 9.

FIG. 11 is a sectional view taken along line 11-11 of FIG. 7.

### DETAILED DESCRIPTION

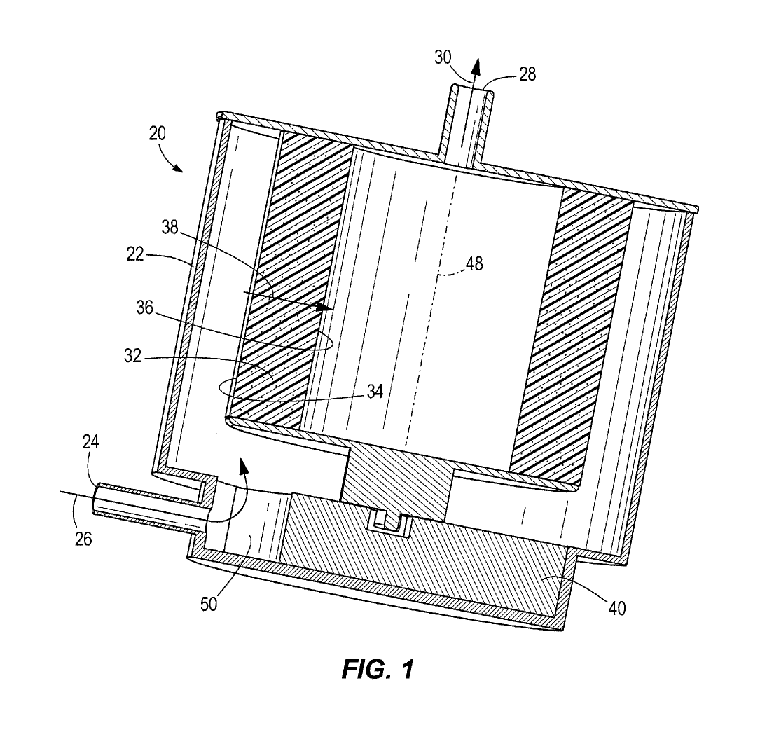

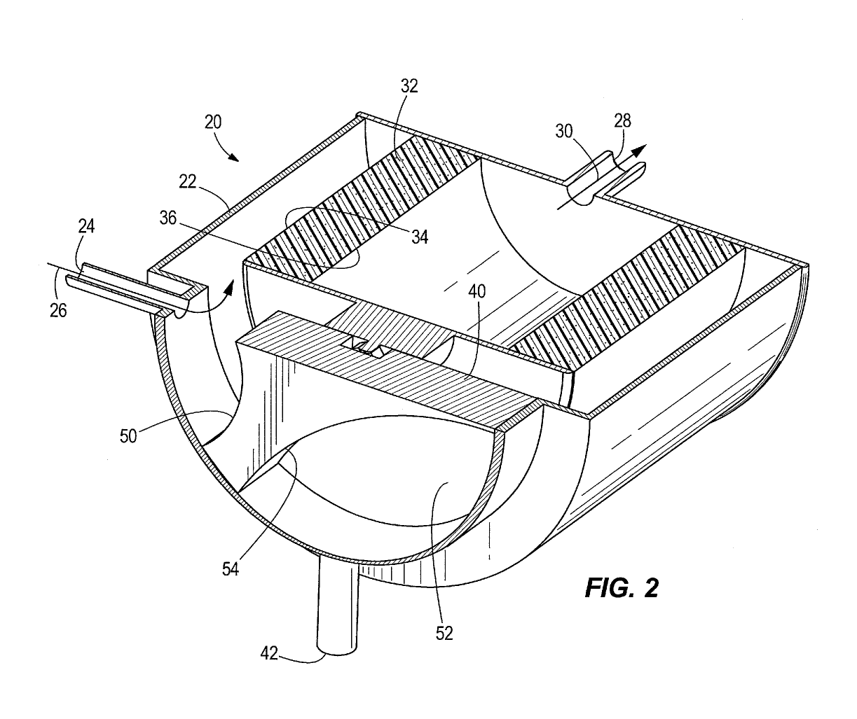

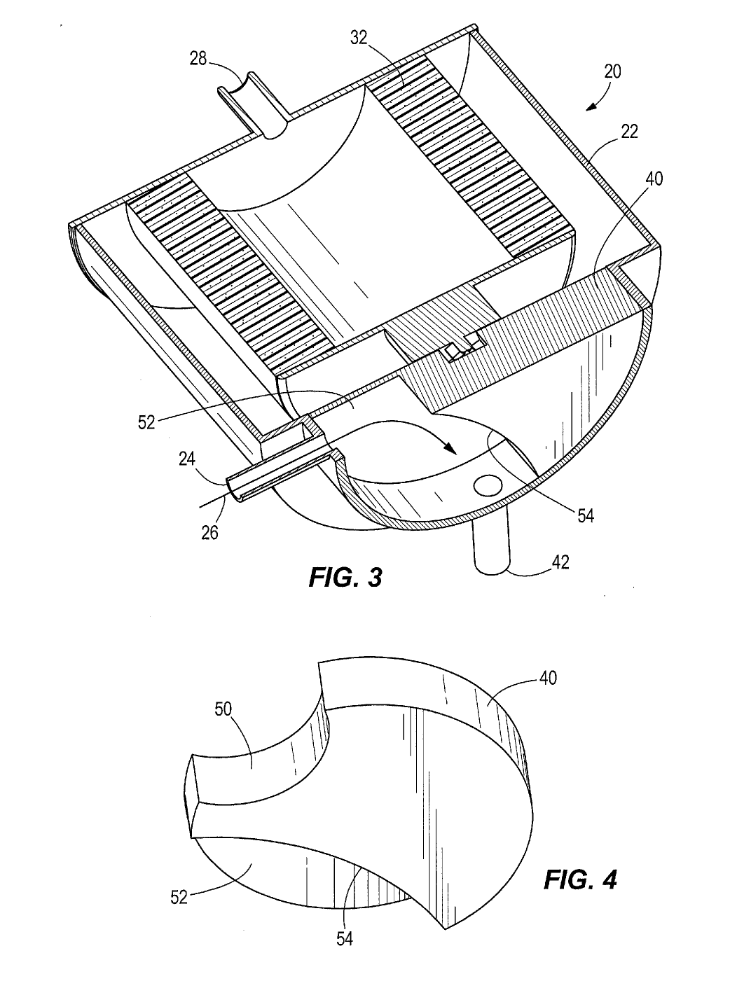

FIG. 1 shows a filter 20 including a housing 22 having an inlet 24 receiving dirty fluid to be filtered, as shown at arrow 26. The housing has an outlet 28 discharging clean filtered fluid after filtering, as shown at arrow 30. A replaceable filter element cartridge 32 is located in the housing and has a dirty side 34 receiving dirty fluid from inlet 24, and has a clean side 36 delivering filtered clean fluid to outlet 28. The fluid is filtered by flowing radially inwardly as shown at arrow 38 from outer dirty side 34 through the filter media to inner side 36. A valve 40 in the housing is actuatable between a first condition, FIGS. 1, 2, passing dirty fluid from inlet 24 to dirty side 34 of the filter cartridge, and a second condition, FIG. 3, blocking passage of dirty fluid from inlet 24 to dirty side 34 of the filter cartridge. In one embodiment, in the noted second condition, FIG. 3, the dirty fluid 26 flows to a second outlet 42 of the housing, for example which may be a bypass to return the dirty fluid, unfiltered, for example to a fuel return line, a sump, etc.

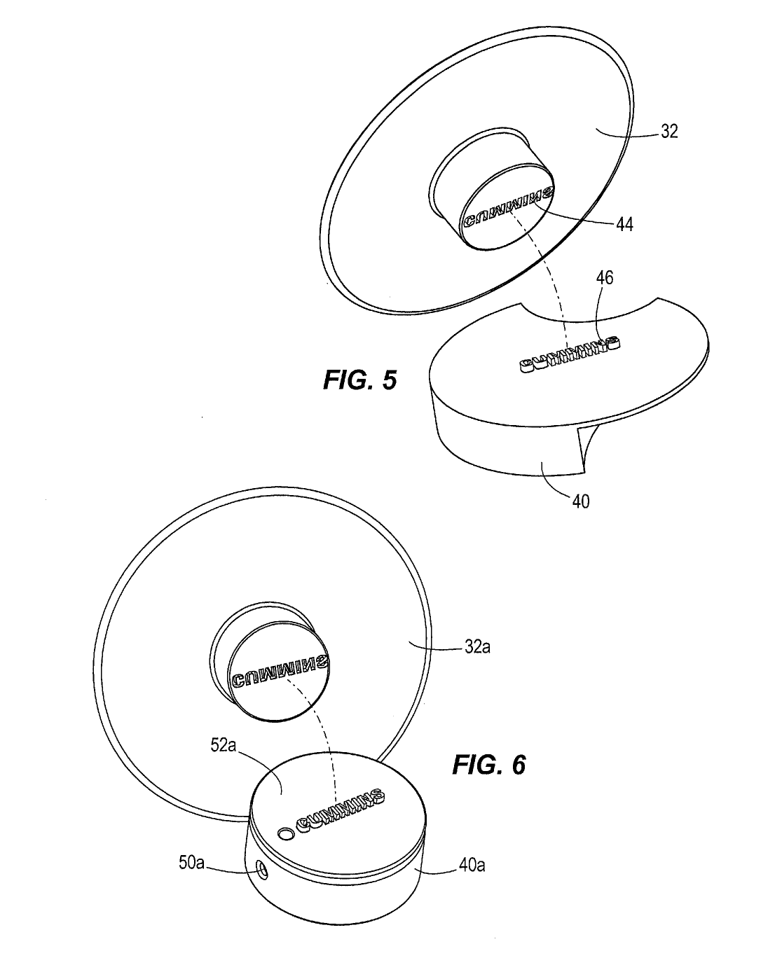

Filter cartridge 32 and valve 40 engage in keyed relation in housing 22. In one embodiment, the filter cartridge has a first interference portion 44, FIG. 5, and valve 40 has a second interference portion 46 engaging first interference portion 44 in mating engagement. Filter cartridge 32 has an operatively mounted position in housing 22, FIGS. 1, 2, passing filtered clean fluid to outlet 28 only when the filter cartridge is in the noted operatively mounted position. Second interference portion 46 permits mounting of filter cartridge 32 in the noted operatively mounted position only when the filter cartridge has the noted first interference portion 44 and only when the filter cartridge 32 and the valve 40 engage in keyed relation and the first interference portion 44 engages the second interference portion 46 in mating engagement. The engagement of first and second interference portions 44 and 46 in mating engagement enables actuation of valve 40 to at least one of the noted first and second conditions.

In one embodiment, the filter cartridge is a driver member movable between first and second user-actuated positions, e.g. rotated a partial-turn about axis 48, and valve 40 is a driven member movable between first and second driven positions, FIGS. 2, 3, respectively, corresponding to the above noted first and second conditions, respectively, if enabled by the noted mating engagement of first and second interference portions 44 and 46 in keyed engagement of filter cartridge 32 and valve 40.

In one embodiment, first interference portion 44 is a first identifier identifying at least one of the filter cartridge, the supplier of the filter cartridge, and the user of the filter cartridge, to enable verification of authenticity. Second interference portion 46 is a second identifier uniquely complemental to the first identifier. In one embodiment, the first identifier is a first embossed identifier, and the second identifier is a second embossed identifier, wherein one of the embossed identifiers is a male embossment with at least one raised convex protuberance, and the other of the embossed identifiers is a female embossment with at least one depressed concave recess, with the depressed concave recessed being uniquely complemental to the raised convex protuberance.

In one embodiment, valve 40 is a rotatable puck, FIG. 4, rotated by filter cartridge 32 in torque transmitting relation between the noted first and second positions providing the noted first and second conditions, respectively. Puck 40 has a first surface 50, FIGS. 1, 2, 4, passing the dirty fluid 26 therealong from inlet 24 of the housing to dirty side 34 of filter cartridge 32 when the puck 40 is in the first position. Puck 40 has a second surface 52, FIG. 3, blocking passage of dirty fluid 26 from inlet 24 of the housing to dirty side 34 of filter cartridge 32 when puck 40 is in the noted second position, FIG. 3. Puck 40 has a third surface 54 passing dirty fluid 26 therealong from inlet 24 to second outlet 42 when puck 40 is in the noted second position, FIG. 3, wherein dirty fluid 26 passes from inlet 24 along third surface 54 of the puck to second outlet 42 of the housing without passing through filter cartridge 32.

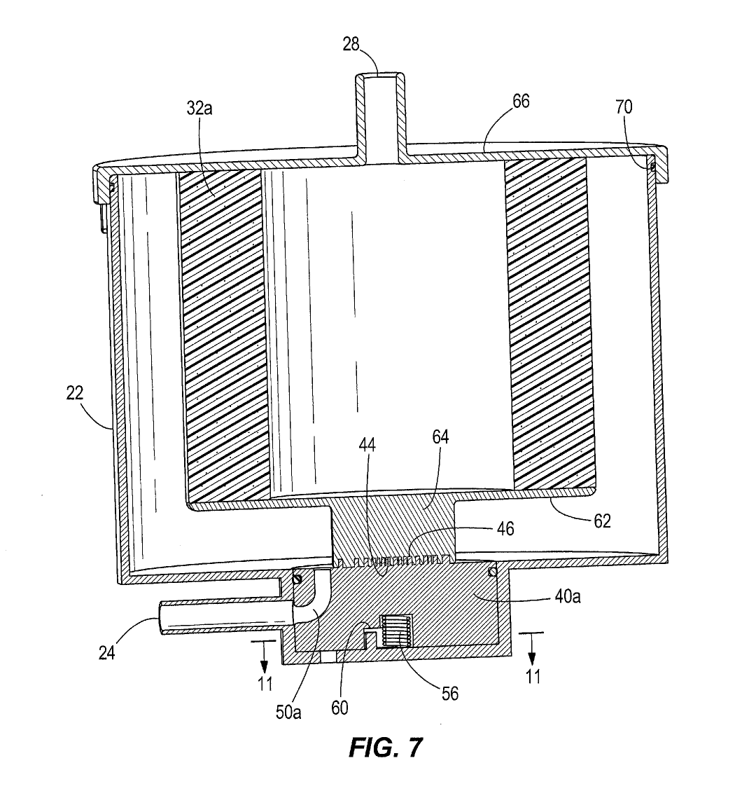

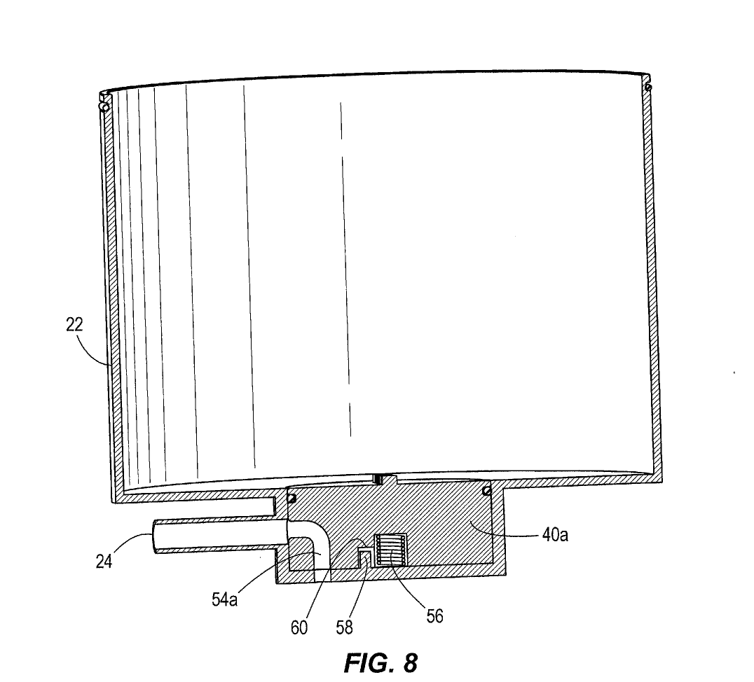

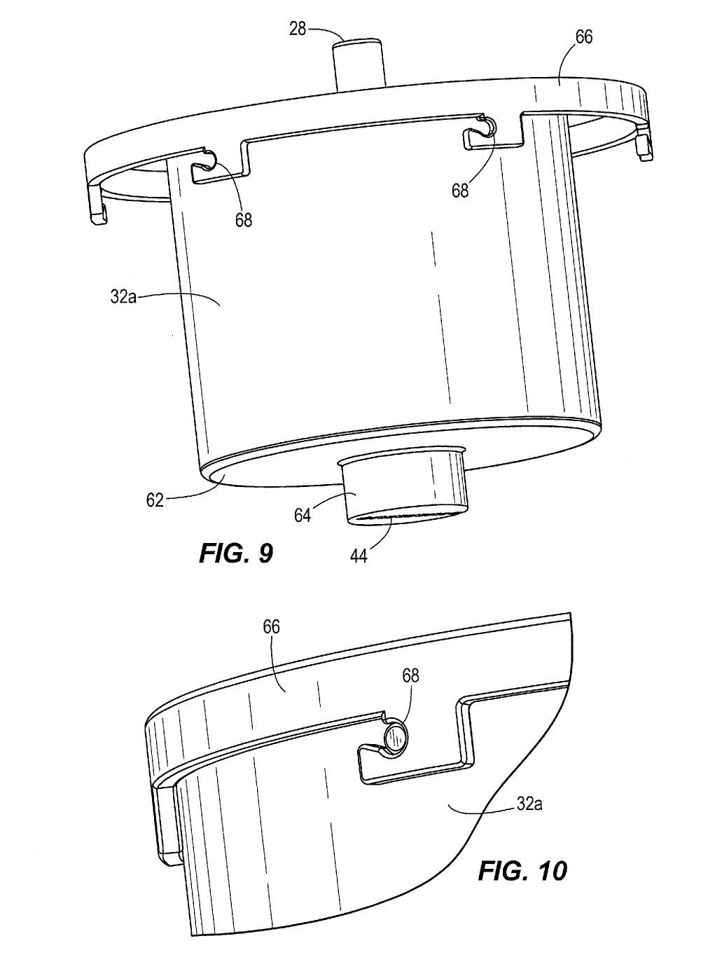

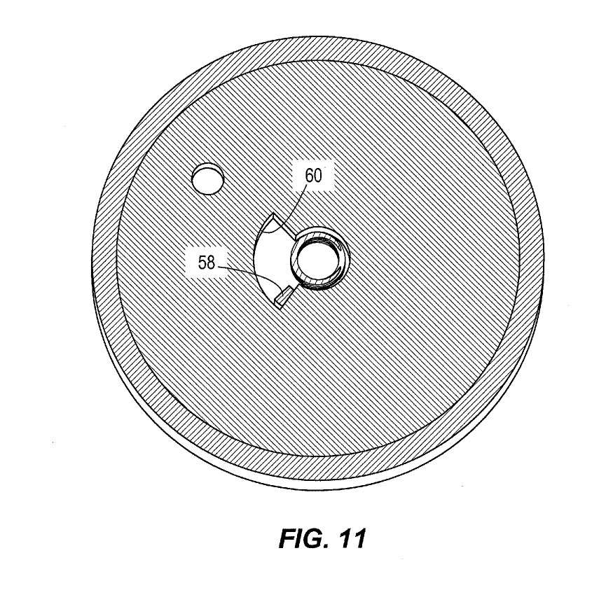

FIGS. 6-11 show another embodiment and use like reference numerals from above where appropriate to facilitate understanding. Rotating puck 40a includes the noted first surface at passage 50a, the noted second surface at 52a, and the noted third surface at passage 54a. A torsion spring 56 bears between the puck and the housing to bias and return the puck to a bypass default condition, FIG. 8. The bottom wall of the housing has a peg or stop 58 extending upwardly into an arcuate slot 60, FIG. 11, in the puck to limit rotation of the latter to the noted partial-turn. Filter cartridge 32a includes a lower endplate 62, FIG. 9, with a trunnion or boss 64 extending downwardly therefrom, on the lower surface of which is the noted first interference portion or embossment 44. The filter cartridge includes a top endplate 66 closing housing 22 and rotational about axis 48 and having a plurality of circumferential hooks 68 to engage and lock with radial spokes or pegs 70 of the housing. Upper and lower plates 66 and 62 are fixedly secured to the filter element 32a therebetween and all rotate together and provide a replaceable filter cartridge.

In the foregoing description, certain terms have been used for brevity, clarity, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

What is claimed is:

1. A filter comprising a housing having an inlet receiving dirty fluid to be filtered, and an outlet discharging clean filtered fluid after filtering, a filter cartridge in said housing, said filter cartridge having a dirty side receiving said dirty fluid from said inlet, and a clean side delivering filtered clean fluid to said outlet, a valve in said housing, said valve being actuatable between a first condition passing said dirty fluid from said inlet of said housing to said dirty side of said filter cartridge, and a second condition blocking passage of said dirty fluid from said inlet of said housing to said dirty side of said filter cartridge, wherein said filter cartridge and said valve engage in keyed relation in said housing.

2. The filter according to claim 1 wherein said filter cartridge has a first interference portion, and said valve has a second interference portion engaging said first interference portion in mating engagement.

3. The filter according to claim 2 wherein:
said filter cartridge has an operatively mounted position in said housing passing filtered clean fluid to said outlet only when said filter cartridge is in said operatively mounted position;
said second interference portion permits mounting of said filter cartridge in said operatively mounted position only when said filter cartridge has said first interference portion and only when said filter cartridge and said valve engage in said keyed relation and said first interference portion engages said second interference portion in said mating engagement.

4. The filter according to claim 3 wherein said engagement of said first and second interference portions in said mating engagement enables actuation of said valve to at least one of said first and second conditions.

5. The filter according to claim 4 wherein said filter cartridge is a driver member movable between first and second user-actuated positions, and said valve is a driven member movable between first and second driven positions corresponding to said first and second conditions, respectively, if enabled by said mating engagement of said first and second interference portions in said keyed engagement of said filter cartridge and said valve.

6. The filter according to claim 2 wherein said first interference portion is a first identifier identifying at least one of the filter cartridge, the supplier of the filter cartridge, and the user of the filter cartridge, to enable verification of authenticity, and said second interference portion is a second identifier.

7. The filter according to claim 6 wherein said second identifier is uniquely complemental to said first identifier.

8. The filter according to claim 7 wherein said first identifier comprises a first embossed identifier, said second identifier comprises a second embossed identifier, one of said embossed identifiers comprising a male embossment with a raised convex protuberance, the other of said embossed identifiers comprising a female embossment with a depressed concave recess, said depressed concave recess being uniquely complemental to said raised convex protuberance.

9. The filter according to claim 1 wherein said valve is a rotatable puck rotated by said filter cartridge in torque transmitting relation between first and second positions providing said first and second conditions, respectively.

10. The filter according to claim 9 wherein said puck has a first surface passing said dirty fluid therealong from said inlet of said housing to said dirty side of said filter cartridge when said puck is in said first position, and a second surface blocking passage of said dirty fluid from said inlet of said housing to said dirty side of said filter cartridge when said puck is in said second position.

11. The filter according to claim 10 wherein said outlet of said housing is a first outlet, said housing has a second outlet, said puck has a third surface passing said dirty fluid therealong from said inlet to said second outlet when said puck is in said second position, wherein said dirty fluid passes from said inlet along said third surface of said puck to said second outlet without passing through said filter cartridge.

12. A replacement filter cartridge for a filter having a housing with an inlet receiving dirty fluid to be filtered, and an outlet discharging clean filtered fluid after filtering, said filter cartridge being in said housing, said filter cartridge having a dirty side receiving said dirty fluid from said inlet, and a clean side delivering filtered clean fluid to said outlet, said housing having a valve actuatable between a first condition passing said dirty fluid from said inlet of said housing to said dirty side of said filter cartridge, and a second condition blocking passage of said dirty fluid from said inlet of said housing to said dirty side of said filter cartridge, wherein said filter cartridge and said valve engage in keyed relation in said housing.

13. The filter cartridge according to claim 12 wherein said filter cartridge has a first interference portion, and said valve has a second interference portion engaging said first interference portion in mating engagement.

14. The filter cartridge according to claim 13 wherein:
said filter cartridge has an operatively mounted position in said housing passing filtered clean fluid to said outlet only when said filter cartridge is in said operatively mounted position;
said second interference portion permits mounting of said filter cartridge in said operatively mounted position only when said filter cartridge has said first interference portion and only when said filter cartridge and said valve engage in said keyed relation and said first interference portion engages said second interference portion in said mating engagement.

15. The filter cartridge according to claim 14 wherein said engagement of said first and second interference portions in said mating engagement enables actuation of said valve to at least one of said first and second conditions.

16. The filter cartridge according to claim 15 wherein said filter cartridge is a driver member movable between first and second user-actuated positions, and said valve is a driven member movable between first and second driven positions corresponding to said first and second conditions, respectively, if enabled by said mating engagement of said first and second interference portions in said keyed engagement of said filter cartridge and said valve.

17. The filter cartridge according to claim 13 wherein said first interference portion is a first identifier identifying at least one of the filter cartridge, the supplier of the filter cartridge, and the user of the filter cartridge, to enable verification of authenticity, and said second interference portion is a second identifier.

18. The filter cartridge according to claim 17 wherein said first interference portion is a first identifier identifying at least one of the filter cartridge, the supplier of the filter cartridge, and the user of the filter cartridge, to enable verification of authenticity, and said second interference portion is a second identifier.

19. The filter cartridge according to claim 18 wherein said first identifier comprises a first embossed identifier, said second identifier comprises a second embossed identifier, one of said embossed identifiers comprising a male embossment with a raised convex protuberance, the other of said embossed identifiers comprising a female embossment with a depressed concave recess, said depressed concave recess being uniquely complemental to said raised convex protuberance.

20. The filter cartridge according to claim 9 wherein said valve is a rotatable puck rotated by said filter cartridge in torque transmitting relation between first and second positions providing said first and second conditions, respectively.

21. The filter according to claim 20 wherein said puck has a first surface passing said dirty fluid therealong from said inlet of said housing to said dirty side of said filter cartridge when said puck is in said first position, and a second surface blocking passage of said dirty fluid from said inlet of said housing to said dirty side of said filter cartridge when said puck is in said second position.

22. The filter cartridge according to claim 21 wherein said outlet of said housing is a first outlet, said housing has a second outlet, said puck has a third surface passing said dirty fluid therealong from said inlet to said second outlet when said puck is in said second position, wherein said dirty fluid passes from said inlet along said third surface of said puck to said second outlet without passing through said filter cartridge.
